(19) United States
(12) Patent Application Publication
(10) Pub. No.: US 2025/0304138 A1
(43) Pub. Date: Oct. 2, 2025

(54) WHEEL RESISTANCE ASSEMBLY FOR STROLLER

(71) Applicant: Paul Sutton, Wilmington, DE (US)

(72) Inventor: Paul Sutton, Wilmington, DE (US)

(21) Appl. No.: 19/092,609

(22) Filed: Mar. 27, 2025

Related U.S. Application Data
(60) Provisional application No. 63/571,399, filed on Mar. 28, 2024.

(51) Int. Cl. B62B 5/04; A63B 21/00; A63B 21/005; A63B 23/04; A63B 71/06; B62B 7/04

(52) U.S. Cl. CPC B62B 5/0447; A63B 21/005; A63B 23/047; B62B 5/0433; B62B 5/0476; B62B 7/04; A63B 21/00069; A63B 21/00076; A63B 71/0619; A63B 2214/00

(57) ABSTRACT

Exemplary embodiments are directed to a wheel resistance assembly for a stroller. The stroller includes a frame and first and second wheels mounted to the frame. The wheel resistance assembly includes a resistance adjustment component configured to be mounted to the frame of the stroller. The wheel resistance assembly includes a resistance component configured to be mounted to the frame of the stroller at or near the first and second wheels. The resistance adjustment component is connected to or in communication with the resistance component. The resistance adjustment component is capable of being actuated to selectively vary a resistance imparted by the resistance component on the first and second wheels to control an amount of restriction of rotation of the first and second wheels.

### CROSS-REFERENCE TO RELATED APPLICATIONS

This application claims the benefit of a co-pending U.S. Provisional Patent Application No. 63/571,399, which was filed on Mar. 28, 2024. The entire content of the foregoing provisional application is incorporated herein by reference.

### TECHNICAL FIELD

The present disclosure relates to a wheel resistance assembly and, in particular, to a stroller including a wheel resistance assembly that allows an individual to exercise with the stroller.

### BACKGROUND

A variety of baby strollers exist in the industry. In general, strollers have either two rear wheels and two front wheels, or two rear wheels and a single front wheel. Some strollers are specifically designed to allow for safely running, and can include inflatable wheels to allow for use over different terrain. Conventional strollers generally include a wheel lock that can be used when leaving a stroller unattended, the wheel lock engaging both rear wheels to prevent movement of the stroller. However, conventional strollers are designed to reduce resistance to wheels, allowing for easy movement and handling of the stroller, and fail to provide adjustable increase in resistance for purposes of exercising with the stroller.

Thus, a need exists for a wheel resistance assembly that provides customizable resistance to wheels of the stroller for purposes of exercising when walking or running with the stroller. These and other needs are addressed by the wheel resistance assembly of the present disclosure.

### SUMMARY

In accordance with embodiments of the present disclosure, an exemplary wheel resistance assembly for a stroller is provided. The wheel resistance assembly includes a means for adjusting a resistance level located at or near the handlebars of the stroller. This allows for convenient adjustability of the resistance by a user as they walk, jog or run with the stroller. The means for adjusting the resistance level is connected via wired and/or wireless means to resistance components at each of the rear wheels of the stroller. Such resistance components impart a mechanical, electromagnetic, and/or magnetic force on at least a portion of the wheel to increase or reduce the rotational resistance of the wheel. The exemplary wheel resistance assembly can be incorporated directly into the stroller during fabrication, or could alternatively be added to an existing stroller. The wheel resistance assembly therefore provides for a convenient way for exercising with the stroller with adjustability to increase or decrease the difficulty for the user.

In accordance with embodiments of the present disclosure, an exemplary wheel resistance assembly for a stroller is provided. The stroller includes a frame, and first and second wheels mounted to the frame. The wheel resistance assembly includes a resistance adjustment component configured to be mounted to the frame of the stroller, and a resistance component configured to be mounted to the frame of the stroller at or near the first and second wheels. The resistance adjustment component is connected to or in communication with the resistance component. The resistance adjustment component is capable of being actuated to selectively vary a resistance imparted by the resistance component on the first and second wheels to control an amount of restriction of rotation of the first and second wheels.

In some embodiments, the resistance adjustment component can include a housing fixed to the frame of the stroller and a dial rotatably coupled to the housing. In such embodiments, rotation of the dial relative to the housing in one direction can increase the amount of restriction of rotation of the first and second wheels, and rotation of the dial relative to the housing in an opposing direction can decrease the amount of restriction of rotation of the first and second wheels.

In some embodiments, the resistance adjustment component can include a monitor with a user interface. In such embodiments, the user interface can be capable of receiving input regarding the amount of restriction of rotation of the first and second wheels.

In some embodiments, the resistance component can include first and second mounting plates coupled to the frame of the stroller at or near the respective first and second wheels. In such embodiments, the resistance component can include permanent magnets secured by each of the first and second mounting plates. In some embodiments, the first and second mounting plates and the permanent magnets can define a semi-circular configuration. Each of the first and second mounting plates can secure an array of the permanent magnets. The permanent magnets secured by each of the first and second mounting plates can be disposed above conductive plates associated with the respective first and second wheels of the stroller.

The permanent magnets can impart a magnetic force on the conductive plates that corresponds with the amount of restriction of rotation of the first and second wheels. The resistance adjustment component is capable of being actuated to simultaneously move the first and second mounting plates and the permanent magnets closer to the conductive plates associated with the respective first and second wheels of the stroller to increase the resistance by the resistance component on the first and second wheels. The resistance adjustment component is capable of being actuated to simultaneously move the first and second mounting plates and the permanent magnets further from the conductive plates associated with the respective first and second wheels of the stroller to decrease the resistance by the resistance component on the first and second wheels.

In some embodiments, the resistance component can include electromagnets secured to the frame of the stroller at or near the first and second wheels. The electromagnets can be secured to the frame by mounting brackets. The electromagnets can be disposed above conductive plates associated with the respective first and second wheels of the stroller. The electromagnets can impart a magnetic force on the conductive plates that corresponds with the amount of restriction of rotation of the first and second wheels. The resistance adjustment component can be capable of being actuated to simultaneously increase the magnetic force of the electromagnets imparted on the conductive plates to increase the resistance by the resistance component on the first and second wheels. The resistance adjustment component can be capable of being actuated to simultaneously decrease the magnetic force of the electromagnets imparted on the conductive plates to decrease the resistance by the resistance component on the first and second wheels.

In accordance with embodiments of the present disclosure, an exemplary stroller is provided. The stroller includes a frame, first and second wheels mounted to the frame, a resistance adjustment component of a wheel resistance assembly mounted to the frame, and a resistance component of the wheel resistance assembly mounted to the frame at or near the first and second wheels. The resistance adjustment component is connected to or in communication with the resistance component. The resistance adjustment component is capable of being actuated to selectively vary a resistance imparted by the resistance component on the first and second wheels to control an amount of restriction of rotation of the first and second wheels.

In accordance with embodiments of the present disclosure, an exemplary method of stroller use is provided. The method includes mounting a resistance adjustment component of a wheel resistance assembly to a frame of a stroller. The method includes mounting a resistance component of the wheel resistance assembly to the frame of the stroller at or near first and second wheels of the stroller. The method includes selectively receiving input at the resistance adjustment component regarding a desired level of resistance to be imparted by the resistance component on the first and second wheels. Based on the input, the method includes varying the resistance imparted by the resistance component on the first and second wheels to control an amount of restriction of rotation of the first and second wheels.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed wheel resistance assembly for a stroller, reference is made to the accompanying figures, wherein:

FIG. 1 is rear view of a stroller including an exemplary wheel resistance assembly according to the present disclosure, the wheel resistance assembly including a resistance adjustment component in the form of a dial and a resistance component in the form of permanent magnets.

FIG. 2 is a perspective detailed view of a resistance adjustment component of a stroller of FIG. 1.

FIG. 3 is a perspective detailed view of a resistance component of a stroller of FIG. 1.

FIG. 4 is a perspective detailed view of a resistance component of a stroller of FIG. 1.

FIG. 5 is a perspective detailed view of a resistance component of a stroller of FIG. 1.

FIG. 6 is a perspective detailed view of a resistance adjustment component of a stroller of FIG. 1.

FIG. 7 is perspective view of a stroller including an exemplary wheel resistance assembly according to the present disclosure, the wheel resistance assembly including a resistance adjustment component in the form of a monitor and a resistance component in the form of permanent magnets.

FIG. 8 is a perspective detailed view of a resistance component of a stroller of FIG. 7.

FIG. 9 s a perspective detailed view of a resistance component of a stroller of FIG. 7.

FIG. 10 is a perspective detailed view of a resistance component of a stroller of FIG. 7.

FIG. 11 is a rear detailed view of a resistance component of a stroller of FIG. 7.

FIG. 12 is perspective view of a stroller including an exemplary wheel resistance assembly according to the present disclosure, the wheel resistance assembly including a resistance adjustment component in the form of a monitor and a resistance component in the form of electromagnets.

FIG. 13 is a rear view of a stroller of FIG. 12.

FIG. 14 is a perspective detailed view of a resistance adjustment component of a stroller of FIG. 12.

FIG. 15 is a perspective detailed view of a resistance component of a stroller of FIG. 12.

FIG. 16 is a perspective detailed view of a resistance component of a stroller of FIG. 12.

FIG. 17 is a perspective detailed view of a resistance component of a stroller of FIG. 12.

FIG. 18 is a rear detailed view of a resistance component of a stroller of FIG. 12.

FIG. 19 is a perspective view of a stroller including a wheel resistance assembly of FIG. 1.

FIG. 20 is a perspective view of a stroller including handles according to the present disclosure.

FIG. 21 is a rear view of a stroller including handles of FIG. 20.

FIG. 22 is a block diagram of an example computing device in accordance with one or more embodiments of the present disclosure.

### DESCRIPTION OF EXEMPLARY EMBODIMENTS

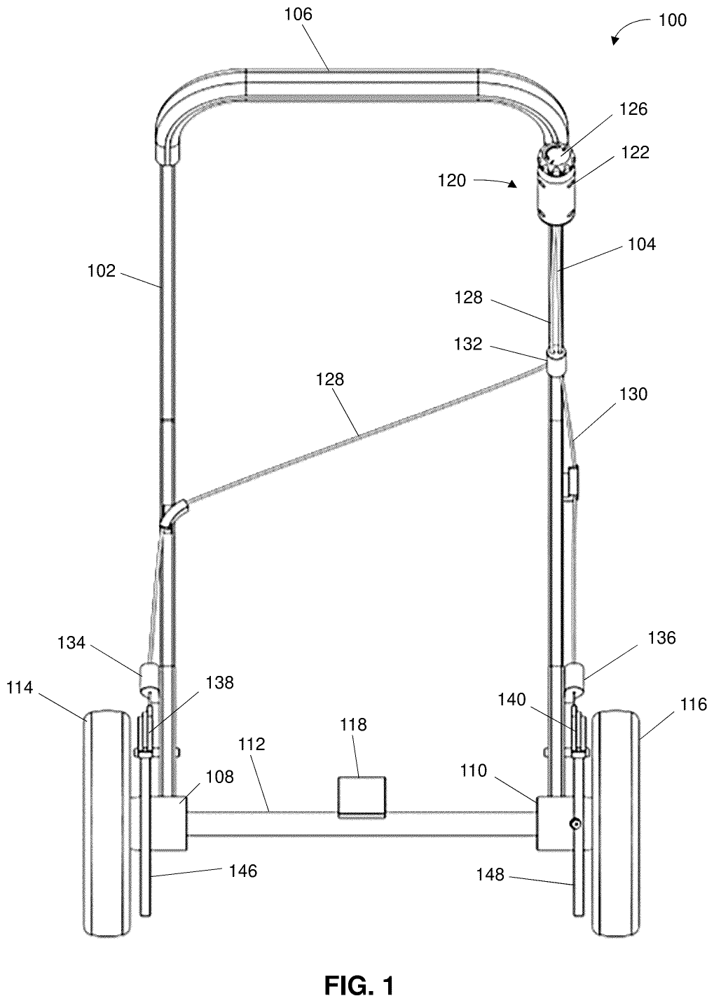

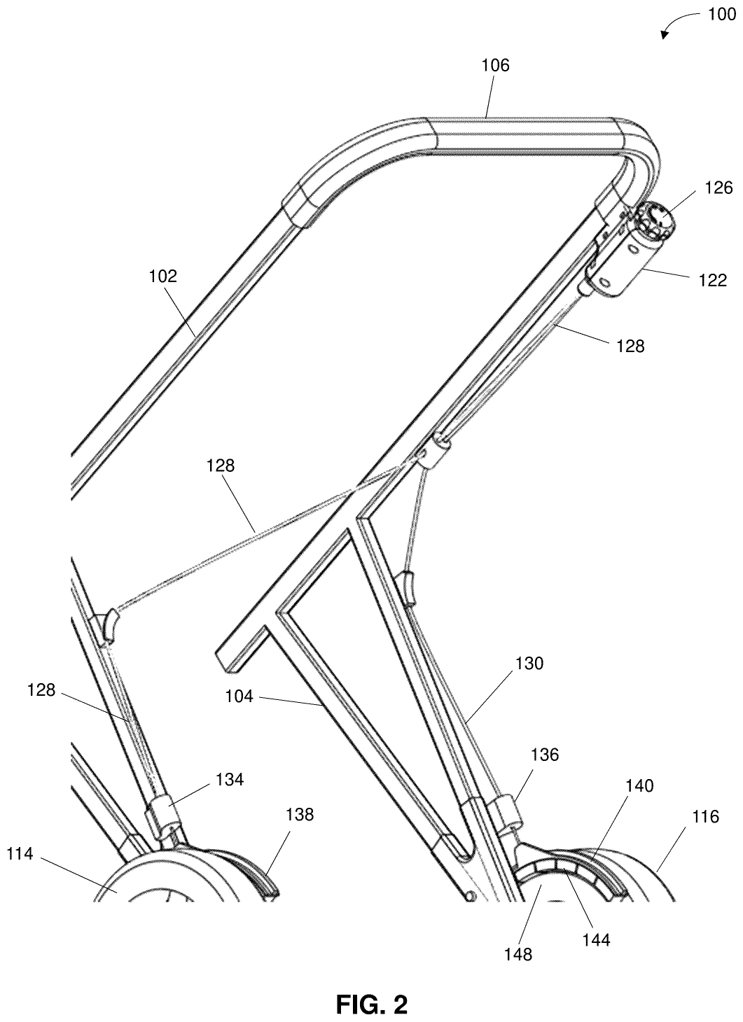

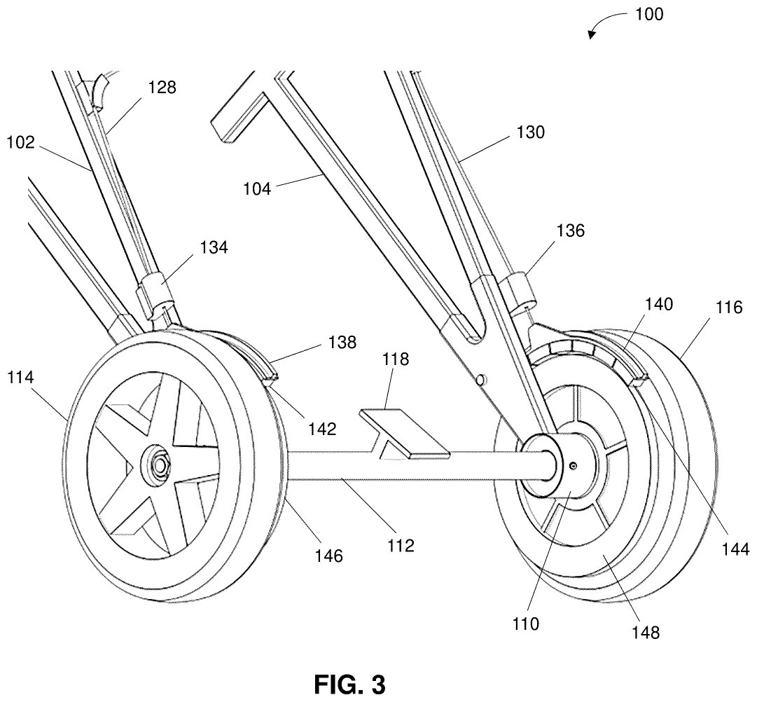

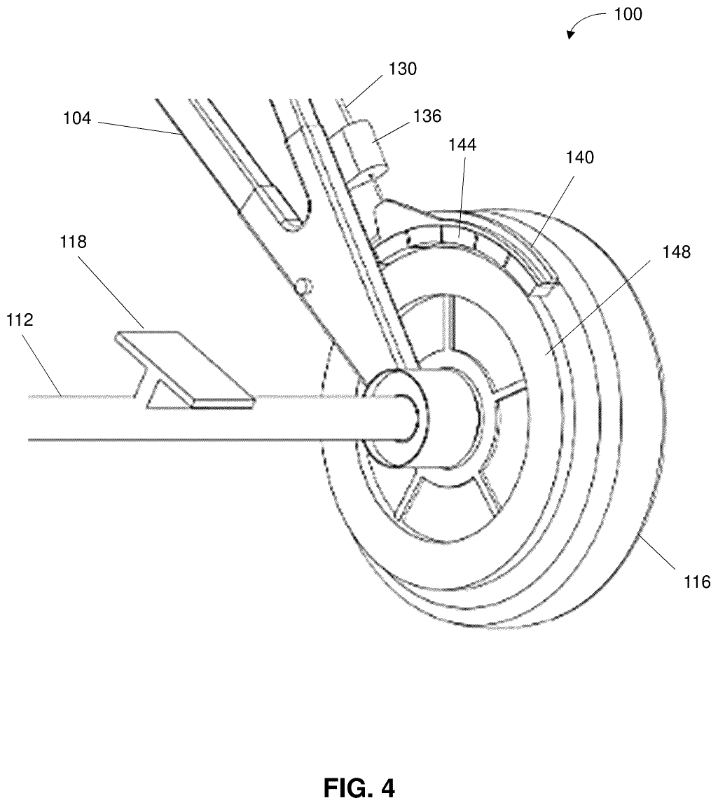

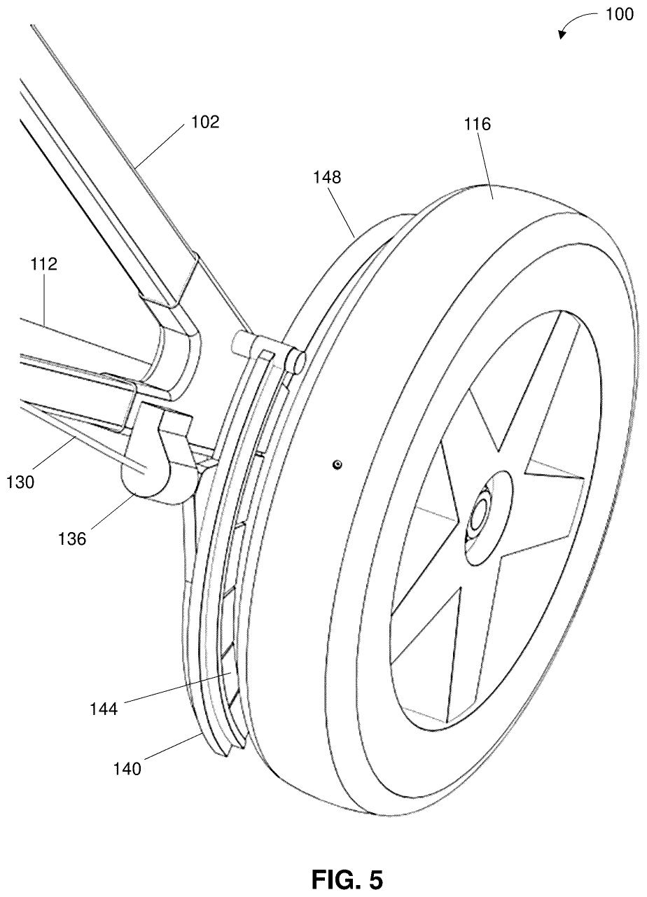

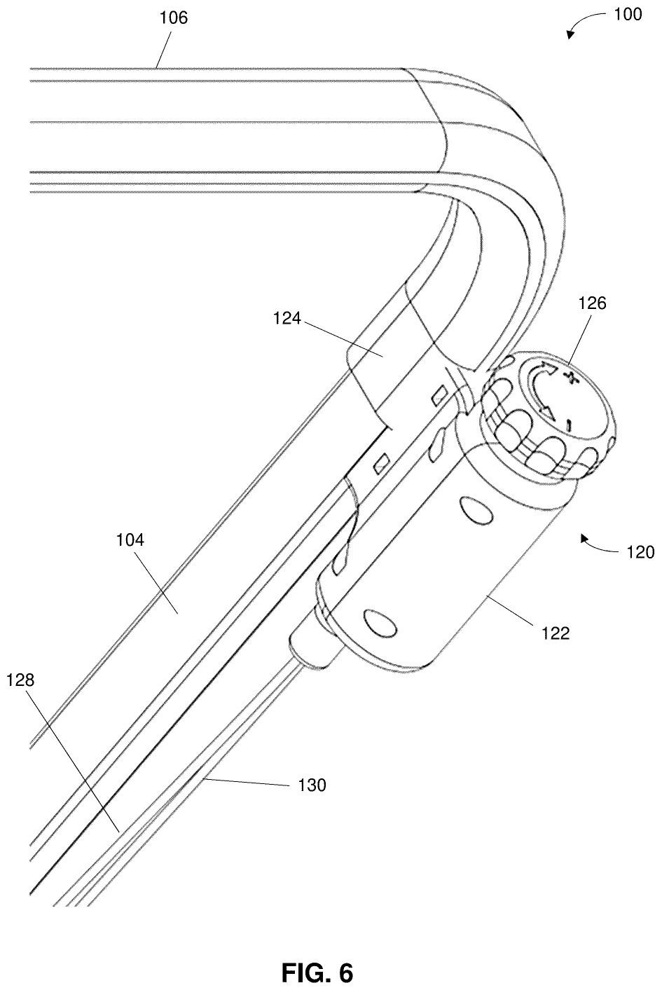

FIGS. 1-6 are perspective, rear and detailed views of a stroller 100 including an exemplary wheel resistance assembly. The stroller 100 generally includes right and left frame sections 102, 104 connected at the top of the stroller 100 by handlebars 106. The handlebars 106 and frame sections 102, 104 can be collectively referred to herein as the frame. In some embodiments, the connection of the frame sections 102, 104 with the handlebars 106 can include a joint that allows for pivoting of the handlebars 106 relative to the frame sections 102, 104. The angle of the handlebars 106 can thereby be adjusted to provide for optimized comfort and grip to the user.

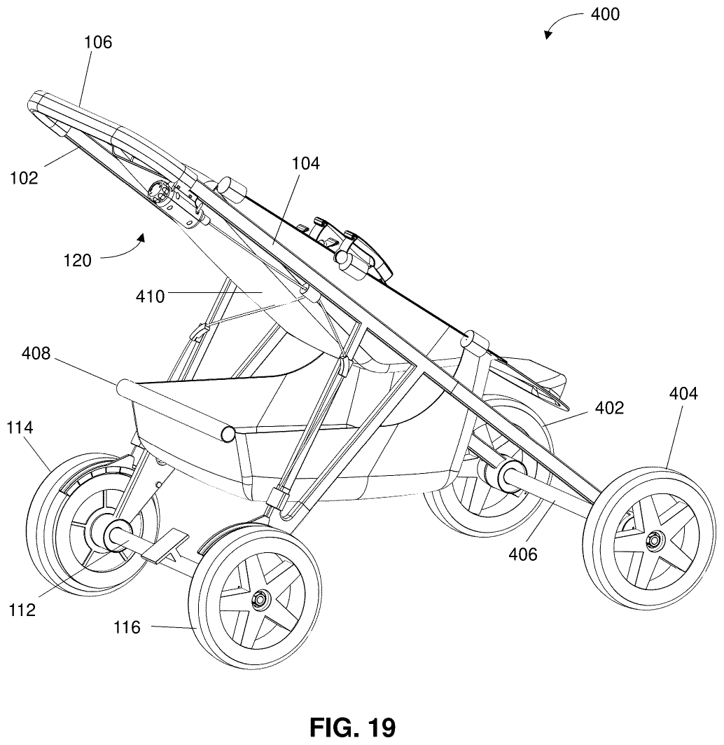

The bottom of the frame sections 102, 104 is coupled to respective bearings 108, 110 of the stroller 100. The bearings 108, 110 include inwardly facing openings that receive an axle 112 for a pair of rear wheels 114, 116 of the stroller 100. Although not illustrated, it should be understood that the frame of the stroller 100 can extend further frontward and connect to one or two front wheels, as is known in the industry. For example, FIG. 19 illustrates a stroller 400 capable of incorporating any of the wheel resistance assemblies discussed herein. The stroller 400 includes one or more front wheels 402, 404 connected to a front axle 406, and can include a storage area 408 underneath the seat 410. Still with reference to FIGS. 1-6, the bearings 108, 110, in turn, are coupled to the wheels 114, 116 and allow the wheels 114, 116 to rotate relative to the frame sections 102, 104. The stroller 100 can include a wheel lock or brake 118 coupled to the axle 112. Engagement of the brake 118 prevents rotation of the wheels 114, 116 relative to the frame sections 102, 104.

The wheel resistance assembly associated with the stroller 100 includes a resistance adjustment component 120 in the form of an adjustable dial for selectively customizing the resistance provided to the wheels 114, 116. The adjustment component 120 includes a housing or base 122 fixedly coupled to the frame section 104 (or handlebars 106) with a mounting bracket 124. The adjustment component 120 includes a dial 126 movably or rotatably coupled to the base 122. For example, the dial 126 can include an arrow pointing to “+” and “−” on opposing ends, indicating that rotation in one direction increases the resistance on the wheels 114, 116, and rotation in the opposing direction decreases the resistance on the wheels 114, 116.

From the bottom of the base 122 of the adjustment component 120, two cables 128, 130 extend downward along the frame section 104. Upon reaching a guide 132 mounted to the frame section 104, the cable 128 extends to the frame section 102, while the cable 130 continues downward along the frame section 104. The cables 128, 130 extend further downward along the respective frame sections 102, 104 and pass through guides 134, 136 mounted to the frame sections 102, 104 above or near the wheels 114, 116.

The ends of the cables 128, 130 are coupled to respective mounting plates 138, 140, each configured to secure an array of permanent magnets 142, 144. In some embodiments, rather than an array of magnets, a single semi-circularly shaped permanent magnet can be used. The mounting plates 138, 140 and the permanent magnets 142, 144 collectively define a resistance component of the stroller 100. In some embodiments, rather than permanent magnets 142, felt or rubber pads can be used to provide a mechanical force through friction on the plates 146, 148. The mounting plates 138, 140 can define a semi-circular configuration which couples and orients the permanent magnets 142, 144 in a semi-circular orientation. The inner diameter formed by the permanent magnets 142, 144 is complementary to an outer diameter of a steel resistance plate 146, 148 mounted to the wheels 114, 116. The plates 146, 148 rotate with the wheels 114, 116 during use of the stroller 100. In particular, the plates 146, 148 are incapable of rotating independently from the wheels 114, 116. The plates 146, 148 can define substantially flat side surfaces and a uniform, flat perimeter circumferential edge.

The permanent magnets 142, 144 are oriented directly above the respective plates 146, 148 and can initially be spaced from the perimeter edge of the plates 146, 148. Rotation of the dial 126 of the resistance adjustment component 120 acts on a return spring disposed within the base 122 of the adjustment component 120 which, in turn, acts on the cables 128, 130. If the dial 126 is rotated to increase the resistance, the mounting plates 138, 140 (and the permanent magnets 142, 144) are simultaneously moved closer to the perimeter edge of the plates 146, 148 such that the magnetic force of the permanent magnets 142, 144 acts on the conductive steel plates 146, 148. The closer the permanent magnets 142, 144 are to the edge of the plates 146, 148, the greater the magnetic force is felt by the plates 146, 148 and, therefore, the greater the resistance to the rotation of the plates 146, 148. Because the plates 146, 148 are fixedly coupled to the wheels 114, 116, resistance to the plates 146, 148 simultaneously provides resistance to turning of the wheels 114, 116.

In some embodiments, a forward force of about 18 N would be needed to push a stroller (including a baby and stroller) weighing about 40 lbs (18 kg). To resist this pushing force, the permanent magnets 142, 144 (or any magnetic or electromagnetic forces discussed herein) would require a torque resistance force on the back axle of about 22 N-m. The harder a person pushes the stroller, the more torque the magnet would need to resist. It should be noted that the forces are provided as an example only, and do not limit operation of the exemplary system discussed herein. A user can therefore use the resistance adjustment component 120 to selectively increase or decrease the resistance to the wheels 114, 116, allowing the user to create a customized experience for exercising with the stroller 100.

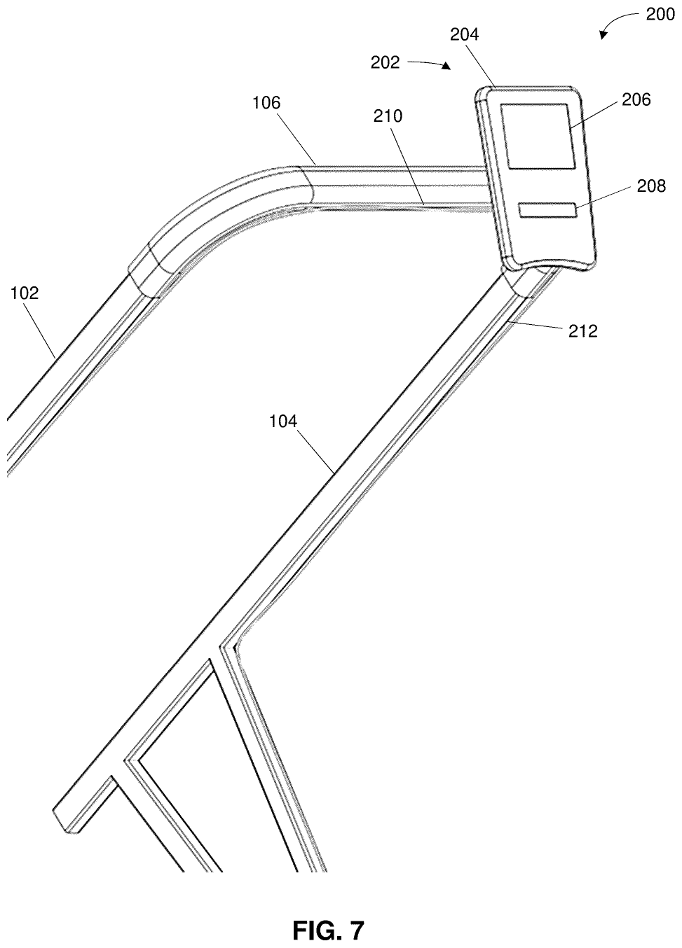

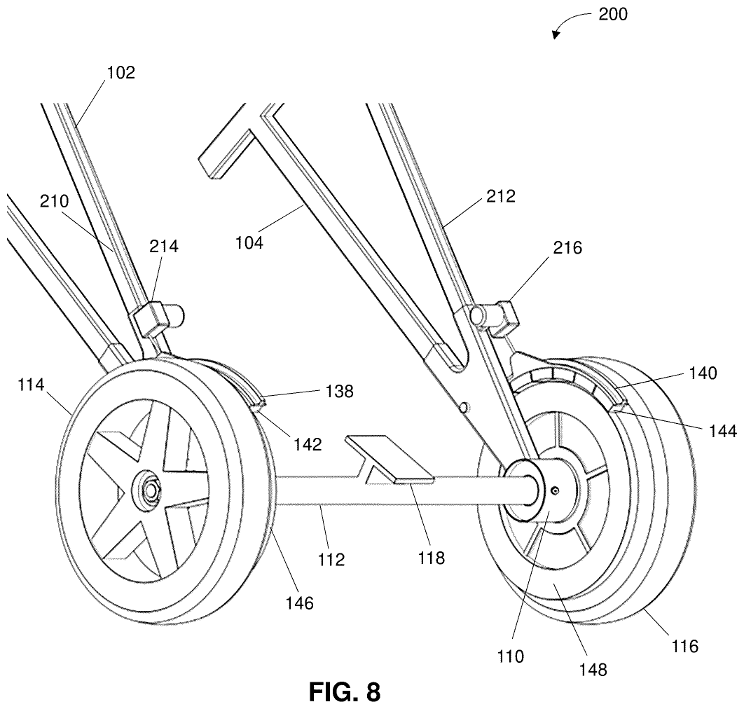

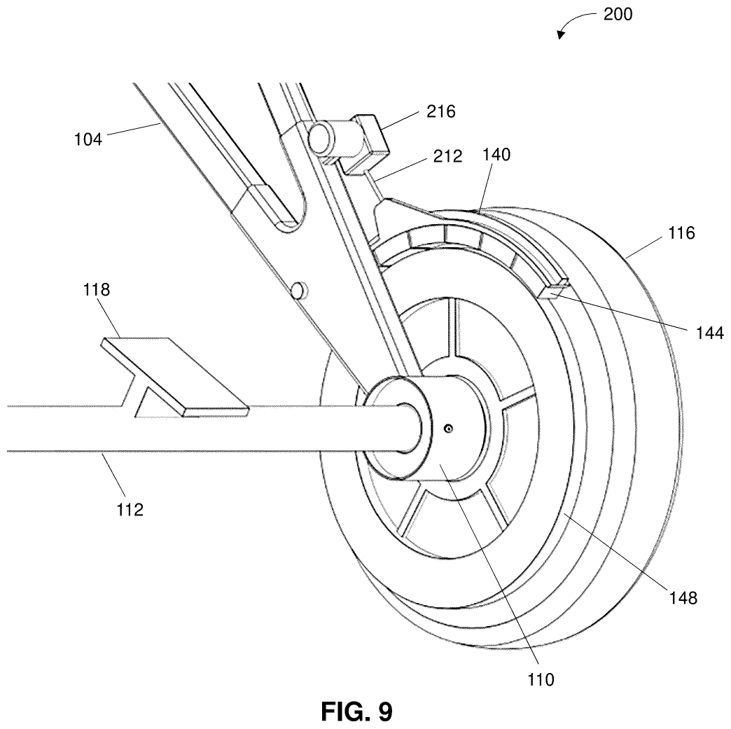

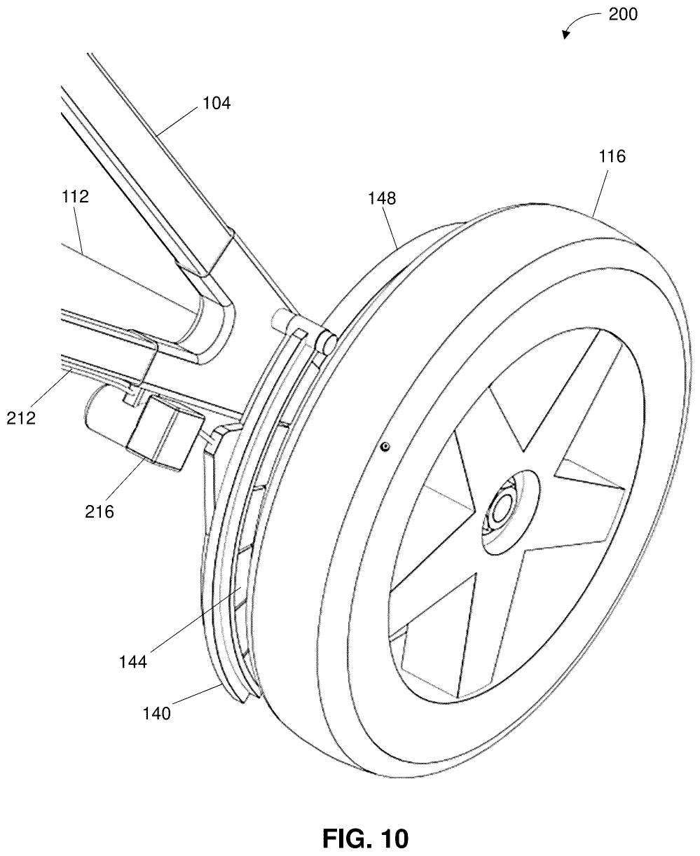

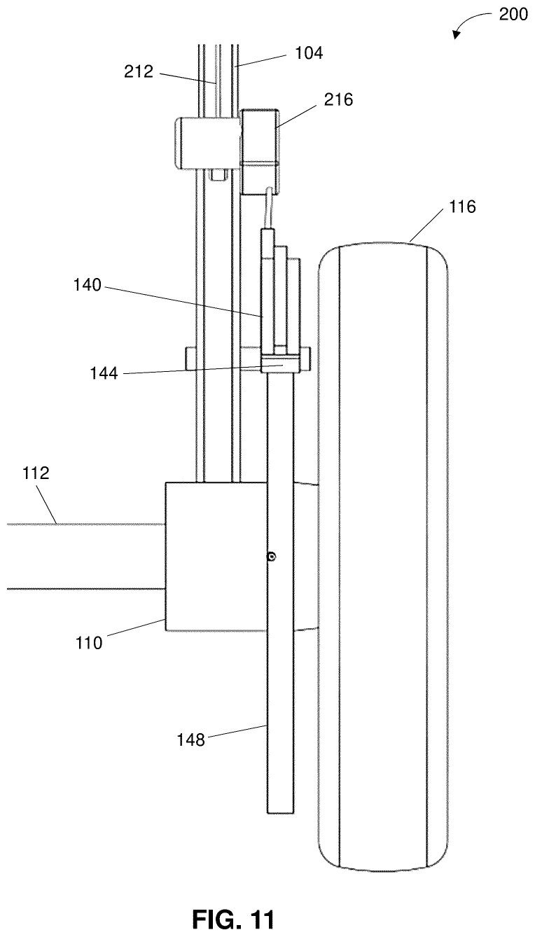

FIGS. 7-11 are perspective, rear and detailed views of a stroller 200 including another exemplary wheel resistance assembly. The components of the stroller 200 can be substantially similar in structure and function to the stroller 100. Therefore, like reference numbers refer to like structures. Rather than a mechanical dial, the stroller 200 includes a resistance adjustment component in the form of a user interface or monitor 202. The monitor 202 can include a housing 204 with a screen 206 (e.g., a graphical user interface). The monitor 202 can include input features 208 (e.g., keys, buttons, or the like) for controlling operation of the monitor 202.

Control wires 210, 212 extend from the monitor 202 along the frame sections 102, 104, and electrically connect the monitor 202 to actuation motors 214, 216 mounted to the frame sections 102, 104 at or near the wheels 114, 116. The actuation motors 214, 216 are mechanically coupled to respective mounting plates 138, 140, which hold the array of permanent magnets 142, 144. The monitor 202 sends signals to the actuation motors 214, 216 upon receiving input from the user, and the control wires 210, 212 relay these command signals to the actuation motors 214, 216 to either move the mounting plates 138, 140 closer or farther from the edge of the plates 146, 148. The actuation motors 214, 216 can include a return spring that maintains the desired position of the permanent magnets 142, 144 relative to the plates 146, 148. Operation of the stroller 200 is therefore similar to the stroller 100, in that the closer the permanent magnets 142, 144 to the plates 146, 148, the greater the rotational resistance on the plates 146, 148 and the wheels 114, 116.

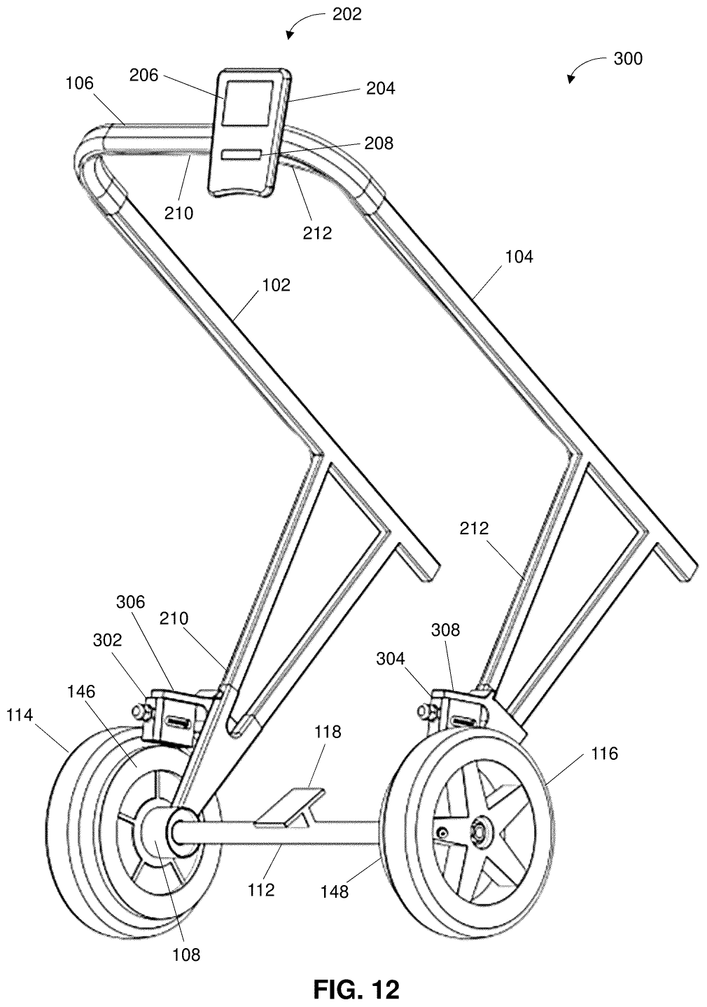

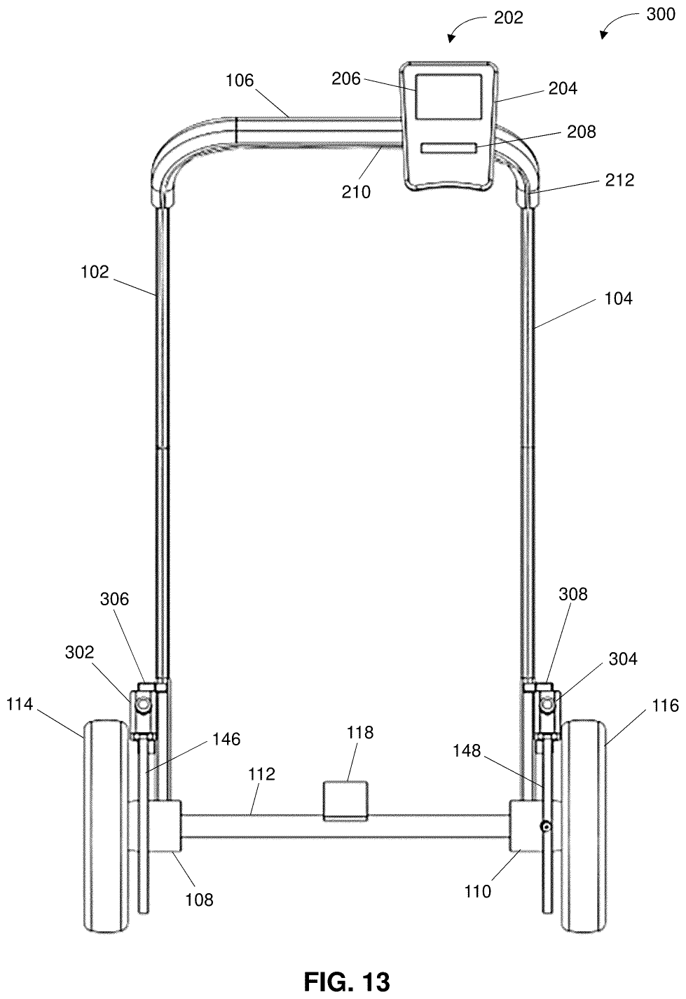

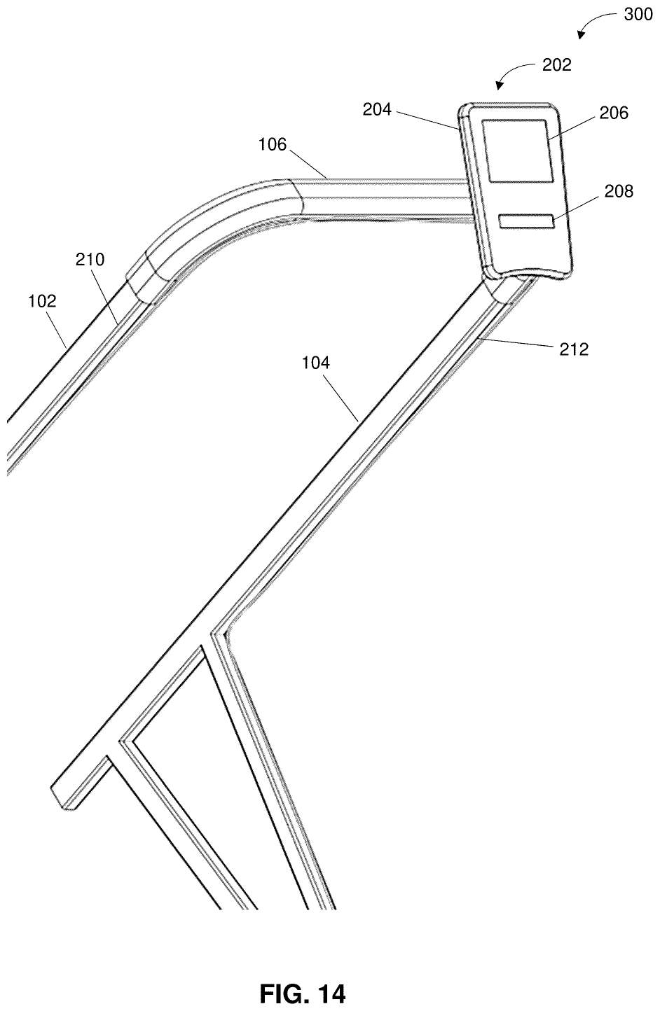

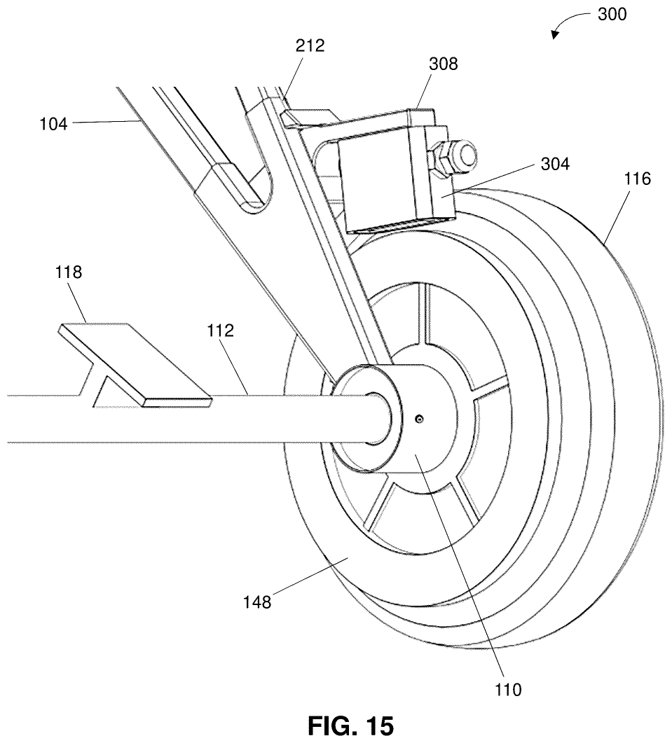

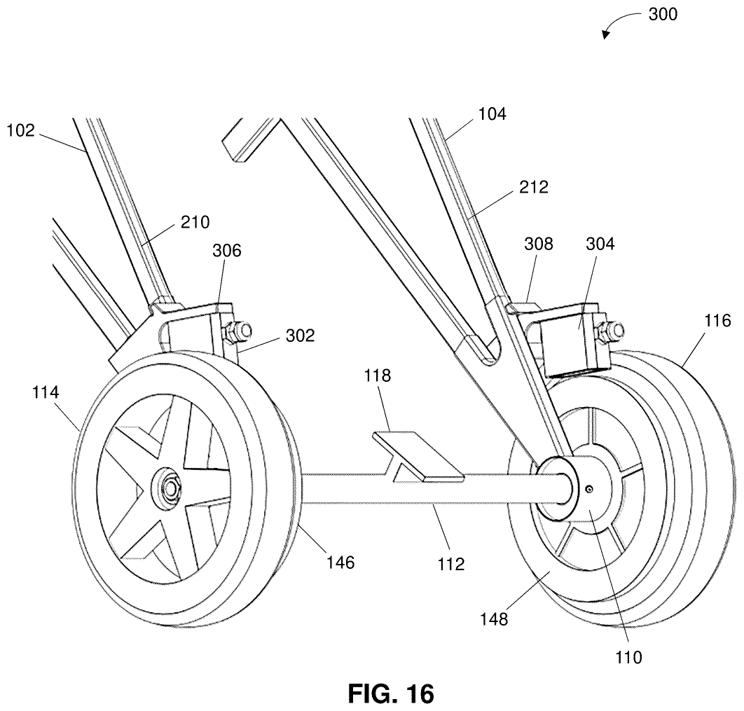

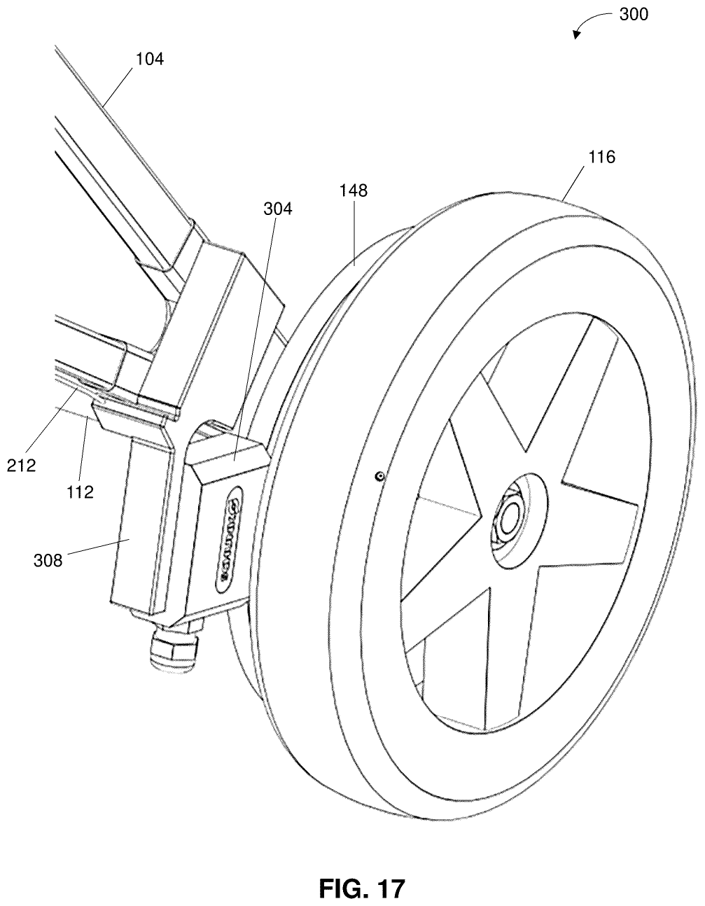

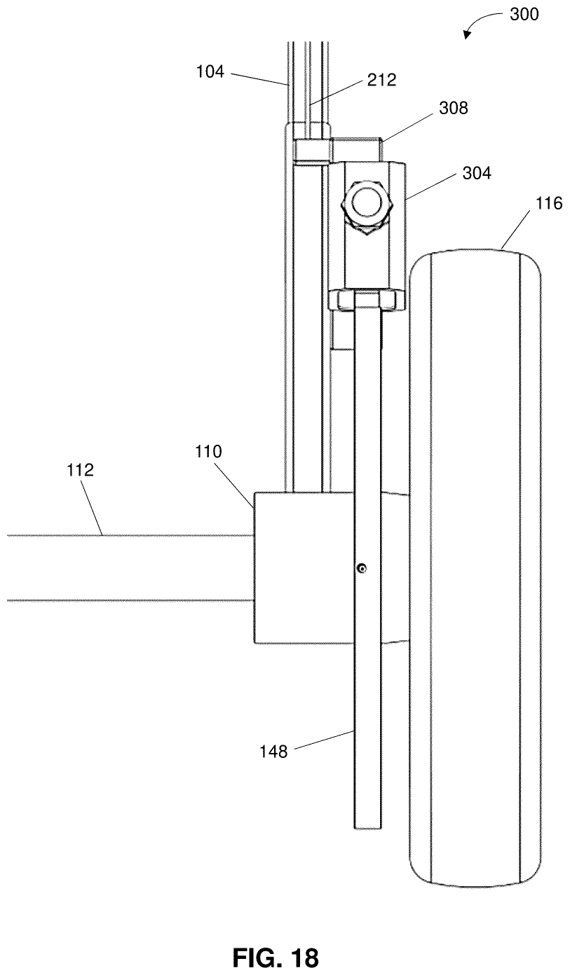

FIGS. 12-18 are perspective, rear and detailed views of a stroller 300 including another exemplary wheel resistance assembly. The components of the stroller 300 can be substantially similar in structure and function to the stroller 100, 200. Therefore, like reference numbers refer to like structures. Rather than permanent magnets, the stroller 300 includes a resistance component in the form of electromagnets 302, 304 mounted at or near the wheels 114, 116 at the frame sections 102, 104. Mounting brackets 306, 308 can secure the electromagnets 302, 304 to the frame sections 102, 104.

The control wires 210, 212 send signals from the monitor 202 to the electromagnets 302, 304 based on input from the user. The electromagnets 302, 304 are positioned adjacent to the perimeter edge of the plates 146, 148. The signals adjust the magnet strength of the electromagnets 302, 304. The greater the magnetic force imparted by the electromagnets 302, 304 on the plates 146, 148, the greater the resistance on rotation of the plates 146, 148 and the wheels 114, 116. As such, different configurations of resistance adjustment are provided for convenient, selective adjustment of the resistance on the wheels 114, 116 of the stroller 300.

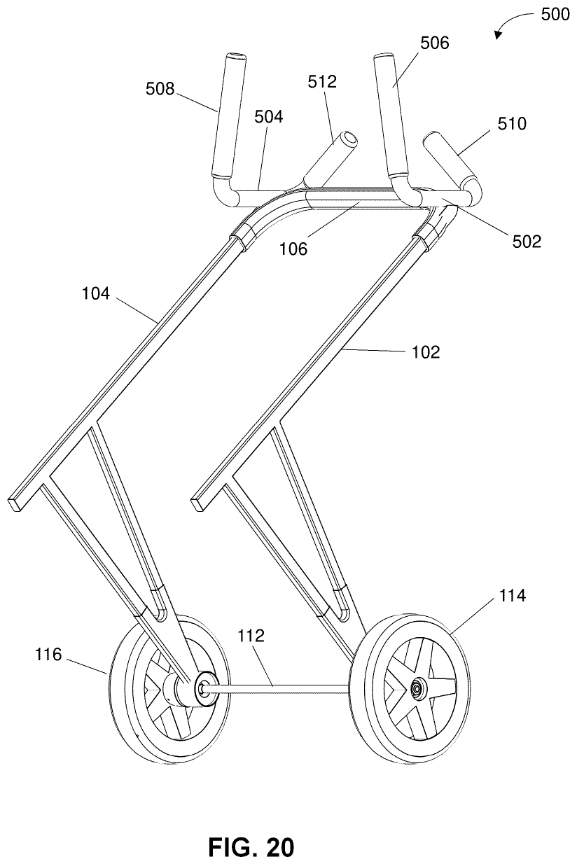

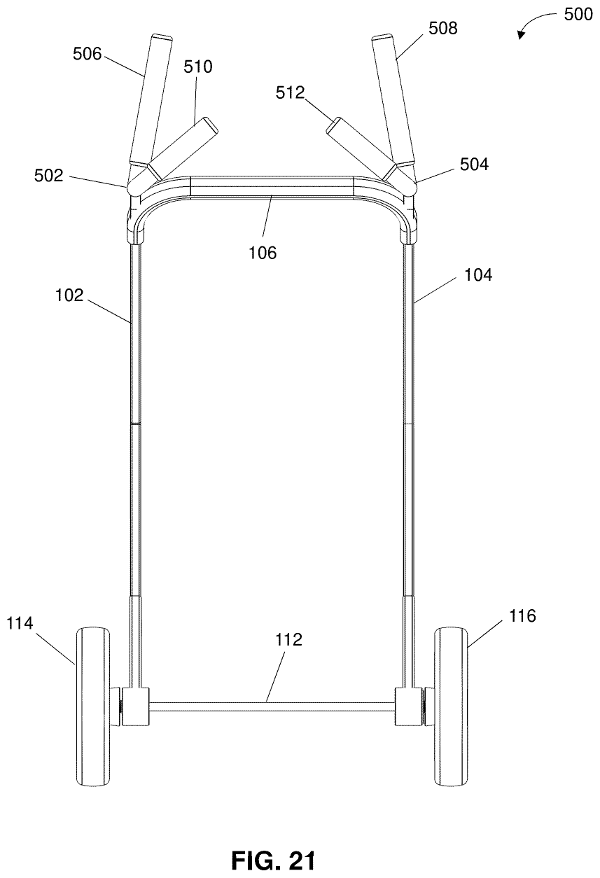

FIGS. 20-21 show a stroller 500 including a frame with adjustable or customizable handles attached to the handlebar 106, i.e., the top frame section. The stroller 500 can include two handles spaced from each other along the handlebar 106. Each handle can include a horizontal mounting section 502, 504 oriented substantially parallel to horizontal and perpendicular to the handlebar 106. Each handle can include a front vertical extension 506, 508 extending from a distal end of the mounting section 502, 504, and a rear vertical extension 510, 512 extending from a proximal end of the mounting section 502, 504. In some embodiments, the front extension 506, 508 can be dimensioned longer than the rear extension 510, 512. In some embodiments, the extensions 506, 508 can be angled at a different angle than the extensions 510, 512 relative to a vertical axis extending perpendicularly to horizontal. In particular, as shown in FIG. 21, the angles at which the extensions 506, 508 and extensions 510, 512 protrude from the handlebar 106 are different. In some embodiments, the extensions 510, 512 can be more inwardly directed (e.g., a smaller angle from the handlebar 106) than the extensions 506, 508. In some embodiments, the angle of the extensions 506, 508, 510, 512 can be adjustable by the user.

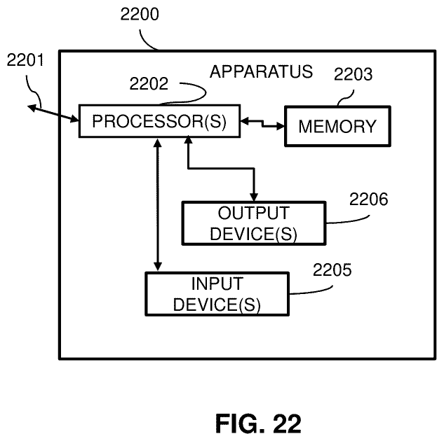

FIG. 22 depicts an example computing device 2200 for use with one or more embodiments described herein. As an example, the computing device 2200 may be a computer to implement certain techniques disclosed herein, such as a computing device to implement the user interface to control the resistance adjustment component (FIG. 7, monitor 202, or the like). In some embodiments, some or all of the steps in the method describe in FIG. 7 may be performed on a single computing device 2200. In some embodiments, the steps in the method described in FIG. 7 may be performed by one, two, three, four, or more computing devices 2200. In some embodiments, the computing device 2200 of the user may be a smartphone or other portable computer device (e.g., a tablet or a laptop).

The computing device 2200 may include one or more processors 2202, memory 2203, one or more input devices 2205, and one or more output devices 2206.

Input to the computing device 2200 may be provided by one or more input devices 2205, provided from one or more input devices in communication with the computing device 2200 via link 2201 (e.g., a wired link or a wireless link; e.g., with a direct connection or over a network), and/or provided from another computer(s) in communication with the computing device 2200 via link 2201.

Output for the computing device 2200 may be provided by one or more output devices 2206, provided to one or more output devices in communication with the computing device 2200 via link 2201, and/or provided from another computer(s) in communication with the computing device 2200 via link 2201. The one or more output devices 2206 may include one more displays and one or more speakers. The output device(s) 2206 may play audio and display video of recorded video according to one or more embodiments described herein.

In some embodiments, one or more input devices 2205 and one or more output devices 2206 may be combined into one or more unitary input/output devices (e.g., a touch screen on a smartphone).

In some embodiments, based on input from one or more input devices 2205 or input from outside the computing device 2200 via the link 2201, the one or more processors 2202 may perform operations as described herein. As an example, user input may be received from the one or more input devices 2205 to adjust the resistance component. As an example, input may be from another computer in communication with the computing device 2200 via link 2201. As an example, input may be from one or more input devices in communication with the computing device 2200 via link 2201, such as the user's cell phone via a short range wireless connection or wired connection.

In some embodiments, the one or more processors 2202 may perform operations as described herein and provide results of the operations as output. As an example, output may be provided to the one or more output devices 2206. As an example, output may be provided to another computer in communication with the computing device 2200 via link 2201. As an example, output may be provided to one or more output devices in communication with the computing device 2200 via link 2201, such as the user's cell phone via a short range wireless connection or wired connection.

The memory 2203 may be accessible by the one or more processors 2202 so that the one or more processors 2202 may read information from and write information to the memory 2203. The memory 2203 may store instructions that, when executed by the one or more processors 2202, implement one or more embodiments described herein. The memory 2203 may be a non-transitory computer readable medium (or a non-transitory processor readable medium) containing a set of instructions thereon for controlling the resistance component, wherein when executed by a processor (such as one or more processors 2202), the instructions cause the processor to perform one or more methods discussed herein. As an example, the computing device 2200 may be a smartphone, and memory of the smartphone may store an app to perform embodiments described herein.

The computing device 2200 may be a computing device for controlling resistance components of the described apparatus and providing workout feedback before, during, or even after the user's operation of the apparatus, the computing device including: one or more processors (such as one or more processors 2202); and memory (such as memory 2203) accessible by the one or more processors, the memory storing instructions that when executed by the one or more processors, cause the computing device to perform one or more methods described herein.

The memory 2203 may be a non-transitory processor readable medium containing a set of instructions thereon for controlling resistance components of the described apparatus and providing workout feedback before, during, or even after the user's operation of the apparatus, wherein when executed by one or more processors (such as one or more processors 2202), the instructions cause the one or more processors to perform one or more methods described herein.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A wheel resistance assembly for a stroller including (i) a frame, and (ii) first and second wheels mounted to the frame, the wheel resistance assembly comprising:
a resistance adjustment component configured to be mounted to the frame of the stroller; and
a resistance component configured to be mounted to the frame of the stroller at or near the first and second wheels;
wherein the resistance adjustment component is connected to or in communication with the resistance component; and
wherein the resistance adjustment component is capable of being actuated to selectively vary a resistance imparted by the resistance component on the first and second wheels to control an amount of restriction of rotation of the first and second wheels.

2. The wheel resistance assembly of claim 1, wherein the resistance adjustment component includes a housing fixed to the frame of the stroller and a dial rotatably coupled to the housing.

3. The wheel resistance assembly of claim 2, wherein rotation of the dial relative to the housing in one direction increases the amount of restriction of rotation of the first and second wheels, and rotation of the dial relative to the housing in an opposing direction decreases the amount of restriction of rotation of the first and second wheels.

4. The wheel resistance assembly of claim 1, wherein the resistance adjustment component includes a monitor with a user interface.

5. The wheel resistance assembly of claim 4, wherein the user interface is capable of receiving input regarding the amount of restriction of rotation of the first and second wheels.

6. The wheel resistance assembly of claim 1, wherein the resistance component includes first and second mounting plates coupled to the frame of the stroller at or near the respective first and second wheels.

7. The wheel resistance assembly of claim 6, wherein the resistance component includes permanent magnets secured by each of the first and second mounting plates.

8. The wheel resistance assembly of claim 7, wherein the first and second mounting plates and the permanent magnets define a semi-circular configuration.

9. The wheel resistance assembly of claim 7, wherein each of the first and second mounting plates secures an array of the permanent magnets.

10. The wheel resistance assembly of claim 7, wherein the permanent magnets secured by each of the first and second mounting plates are disposed above conductive plates associated with the respective first and second wheels of the stroller.

11. The wheel resistance assembly of claim 10, wherein the permanent magnets impart a magnetic force on the conductive plates that corresponds with the amount of restriction of rotation of the first and second wheels.

12. The wheel resistance assembly of claim 10, wherein the resistance adjustment component is capable of being actuated to simultaneously move the first and second mounting plates and the permanent magnets closer to the conductive plates associated with the respective first and second wheels of the stroller to increase the resistance by the resistance component on the first and second wheels.

13. The wheel resistance assembly of claim 10, wherein the resistance adjustment component is capable of being actuated to simultaneously move the first and second mounting plates and the permanent magnets further from the conductive plates associated with the respective first and second wheels of the stroller to decrease the resistance by the resistance component on the first and second wheels.

14. The wheel resistance assembly of claim 1, wherein the resistance component includes electromagnets secured to the frame of the stroller at or near the first and second wheels.

15. The wheel resistance assembly of claim 14, wherein the electromagnets are secured to the frame by mounting brackets.

16. The wheel resistance assembly of claim 14, wherein the electromagnets are disposed above conductive plates associated with the respective first and second wheels of the stroller, and wherein the electromagnets imparts a magnetic force on the conductive plates that corresponds with the amount of restriction of rotation of the first and second wheels.

17. The wheel resistance assembly of claim 16, wherein the resistance adjustment component is capable of being actuated to simultaneously increase the magnetic force of the electromagnets imparted on the conductive plates to increase the resistance by the resistance component on the first and second wheels.

18. The wheel resistance assembly of claim 16, wherein the resistance adjustment component is capable of being actuated to simultaneously decrease the magnetic force of the electromagnets imparted on the conductive plates to decrease the resistance by the resistance component on the first and second wheels.

19. A stroller, comprising:
a frame;
first and second wheels mounted to the frame;
a resistance adjustment component of a wheel resistance assembly mounted to the frame; and
a resistance component of the wheel resistance assembly mounted to the frame at or near the first and second wheels;
wherein the resistance adjustment component is connected to or in communication with the resistance component; and
wherein the resistance adjustment component is capable of being actuated to selectively vary a resistance imparted by the resistance component on the first and second wheels to control an amount of restriction of rotation of the first and second wheels.

20. A method of stroller use, comprising:
mounting a resistance adjustment component of a wheel resistance assembly to a frame of a stroller;
mounting a resistance component of the wheel resistance assembly to the frame of the stroller at or near first and second wheels of the stroller;
selectively receiving input at the resistance adjustment component regarding a desired level of resistance to be imparted by the resistance component on the first and second wheels; and
based on the input, varying the resistance imparted by the resistance component on the first and second wheels to control an amount of restriction of rotation of the first and second wheels.
